(19) United States
(12) Patent Application Publication
(10) Pub. No.: US 2021/0183403 A1
(43) Pub. Date: Jun. 17, 2021

(54) FREQUENCY EXTRACTION METHOD USING DJ TRANSFORM

(71) Applicant: BRAINSOFT INC., Seoul (KR)

(72) Inventor: Dong Jin Kim, Seoul (KR)

(21) Appl. No.: 17/268,444

(22) PCT Filed: Nov. 26, 2019
(86) PCT No.: PCT/KR2019/016347

§ 371 Date: Feb. 12, 2021

(30) Foreign Application Priority Data
Jan. 11, 2019 (KR) 10-2019-0003620

(51) Int. Cl. G10L 21/0364; G10L 21/0308

(52) U.S. Cl. CPC G10L 21/0364; G10L 21/0308

(57) ABSTRACT

A method, of which each step is performed by a computer, for extracting a frequency of an input sound according to an embodiment of the present disclosure comprises the steps of: modeling a plurality of springs which have natural frequencies different from each other and oscillate according to an input sound; calculating transient-state-pure-tone amplitudes of the plurality of modeled springs; calculating expected steady-state amplitudes of the plurality of modeled springs; calculating predicted pure-tone amplitudes based on the expected steady-state amplitudes; calculating filtered pure-tone amplitudes by multiplying the transient-state-pure-tone amplitudes with the predicted pure-tone amplitudes ; and extracting the natural frequency of the spring which corresponds to a local maximum value among the filtered pure-tone amplitudes.

### CROSS-REFERENCE TO RELATED APPLICATIONS

This application is a U.S. National Stage application under 35 U.S.C. § 371 of an International application filed on Nov. 26, 2019 and assigned application number PCT/KR2019/016347, which claimed the benefit of a Korean patent application filed on Jan. 11, 2019 in the Korean Intellectual Property Office and assigned Serial number 10-2019-0003620, the entire disclosures of which are hereby incorporated by reference.

### TECHNICAL FIELD

The present disclosure generally relates to a frequency extraction method, especially to a frequency extraction method which can increase the temporal resolution as well as the frequency resolution simultaneously.

### BACKGROUND

The Short-time Fourier Transform (STFT) is used in various fields dealing with sound, such as speech recognition, speaker recognition, etc. to extract frequencies from a given sound. However, when frequencies are extracted by the STFT, there is a limitation on increasing the temporal resolution as well as the frequency resolution due to the Fourier uncertainty principle. The Fourier uncertainty principle states that if a sound of a short duration is transformed into a frequency component, then the resolution of the frequency component is relatively low, and if a sound with a longer duration is used to obtain a more precise frequency, then the temporal resolution for the instant when the frequency component is extracted decreases.

For example, when using the STFT, assume that a window size is 25 milliseconds, and a rectangular filter is used. The frequency component extracted under these conditions has a resolution of 40 Hz. In that case, even if 420 Hz frequency exists in an input sound, only 400 Hz frequency and 440 Hz frequency appear as the extraction result, and the 420 Hz frequency does not appear. For that reason, the distinction between a pure tone composed of 420 Hz frequency only and a complex tone composed of 400 Hz and 440 Hz frequencies is not clear. Now, assume that 4 kHz frequency exists on the extracted result. The extraction result does not give any information on the time point when the 4 kHz frequency occurred within the 25 milliseconds window. For example, it is not possible to distinguish whether the 4 kHz frequency occurred in the range of 0˜10 milliseconds or in the range of 10˜20 milliseconds.

In order to get a frequency resolution of 20 Hz, the window size should be extended to 50 milliseconds. However, since the temporal resolution is inversely proportionate to the frequency resolution, the temporal resolution decreases due to the 50 milliseconds window. Also, if the window size is reduced to 12.5 milliseconds to increase the temporal resolution, the frequency resolution is lowered to 80 Hz. Due to this trade-off, the temporal resolution and the frequency resolution cannot be improved simultaneously when using the STFT.

### SUMMARY

According to research findings, it is known that human hearing ability is not restricted by the Fourier uncertainty principle. The present disclosure intends to propose the DJ transform method, a new frequency extraction method from understanding of the human hearing ability that improves the temporal resolution as well as the frequency resolution simultaneously based on the operating principle of hair cells constituting the cochlea.

A method, of which each step is performed by a computer, for extracting a frequency of an input sound according to an embodiment of the present disclosure comprises the steps of: modeling a plurality of springs which have natural frequencies different from each other and oscillate according to an input sound; calculating transient-state-pure-tone amplitudes of the plurality of modeled springs; calculating expected steady-state amplitudes of the plurality of modeled springs; calculating predicted pure-tone amplitudes on the basis of the expected steady-state amplitudes; calculating filtered pure-tone amplitudes by multiplying the transient-state-pure-tone amplitudes with the predicted pure-tone amplitudes; and extracting the natural frequency of the spring which corresponds to a local maximum of the filtered pure-tone amplitudes.

A device for extracting a frequency of a sound according to an embodiment of the present disclosure comprises: a spring modeling unit for producing displacements and velocities of a plurality of springs by modeling the plurality of springs which have natural frequencies different from each other and oscillate according to an input sound; and a frequency extracting unit for calculating transient-state-pure-tone amplitudes of the plurality of modeled springs, calculating expected steady-state amplitudes of the plurality of modeled springs, calculating predicted pure-tone amplitudes on the basis of the expected steady-state amplitudes; calculating filtered pure-tome amplitudes by multiplying the transient-state-pure-tone amplitudes with the predicted pure-tone amplitudes, and extracting the natural frequency of the spring which corresponds to a local maximum of the filtered pure-tone amplitude.

A method, of which each step is performed by a computer, for extracting a frequency of an input sound according to an embodiment of the present disclosure comprises the steps of: modeling a plurality of springs which have natural frequencies different from each other and oscillate according to an input sound; estimating an expected steady-state amplitude of a spring of which the amplitude is the highest among the plurality of modeled springs; calculating an energy of the spring of which the amplitude is the highest based on the expected steady-state amplitudes; and calculating an amplitude of the input pure tone based on the energy.

A device for extracting a frequency of an input sound according to an embodiment of the present disclosure comprises: a spring modeling unit for producing displacements and velocities of a plurality of springs by modeling the plurality of springs which have natural frequencies different from each other and oscillate according to an input sound; and a frequency extracting unit for estimating an expected steady-state amplitude of a spring of which the amplitude is the highest among the plurality of modeled springs, calculating energy of a spring of which the amplitude is the highest based on the expected steady-state amplitudes, and calculating an input pure tone amplitude based on said energy.

Said expected steady-state amplitude can be calculated based on the amplitudes at two different time points within a duration of the input sound.

Said expected steady-state amplitude (A_{i, s}) can be calculated by means of the equation below:

$${A}_{i , s} = \frac{{A}_{i} ( {t}_{2} ) - {A}_{i} ( {t}_{1} ) {e}^{- ζ ω ( {t}_{2} - {t}_{1} )}}{1 - {e}^{- ζ ω ( {t}_{2} - {t}_{1} )}}$$

where t₁ and t₂ are two different time points within a duration of input sound, t₂>t₁, Ai(t₁) is an amplitude of any spring among said plurality of springs at t₁, Ai(t₂) is an amplitude of said spring at t₂, ζ is a damping ratio of said spring, ω satisfies the equation ω=ωᵢ\sqrt{1−2ζ²}, where ωᵢ is the natural frequency of said spring.

A difference between the two different time points can be a period of the natural frequency of the corresponding spring.

When one of the two time points is t₁, a sampling rate of the input sound is SR, and a period of the natural frequency of the corresponding spring is T, the other t₂ of the two time points can be calculated by means of the equation below.

t₂=[t₁+SR×T+0.5]

The expected steady-state amplitude can be calculated by substituting amplitudes at least two points in the input duration of the sound into the following equation and using a linear regression analysis.

A(t)=Aₛ+(A_{c}−Aₛ)e^{-ζω(t-t}^{_{c}}⁾

where A(t) is an amplitude of any spring among said plurality of springs at t, Aₛ is the expected steady-state amplitude of said spring, A_{c} is an amplitude of said spring at t_{c}, ζ is a damping ratio of said spring, ω satisfies the equation ω=ωᵢ\sqrt{1−2ζ²}, where ωᵢ is the natural frequency of the spring.

Said modeling step can comprise the steps of: measuring displacements and velocities at time points for each of the plurality of springs; calculating energy at each time point for each of the plurality of springs based on the displacements and the velocities; and calculating an amplitude at each time point for each of the plurality of springs based on said energy.

The number of the plurality of springs may be determined based on a range and a resolution of the frequency to be extracted.

Said method for extracting the frequency of an input sound may be recorded on a computer-readable recording medium according to an embodiment of the present disclosure.

A method for extracting a frequency of an input sound, which is performed by a computer, according to an embodiment of the present disclosure wherein: when the frequency of the input sound maintains a first value by a certain point of time and turns into a second value at the turning point, a result of frequency transform by the certain point of time indicates the first value, and immediately after the turning point, a transient error of the transformed value is within 10% of the second frequency.

According to an embodiment of the present disclosure, a method for extracting a sound frequency, which shows improved temporal and frequency resolution, is provided. Accordingly, sounds having similar frequencies can be further subdivided and classified, and accuracy of speech recognition can be improved by precisely extracting the order of phonemes information from the speech. In addition, a stable speech recognition can be performed in a noisy environment, and the size of data required for speech recognition learning can be reduced.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is an example of a graph showing the displacement of a spring when an external force is zero;

FIG. 2 is an example of a graph showing the changes in amplitude of a spring when an external force is applied and disappears;

FIG. 3 is a flowchart showing a method for extracting a frequency of an input sound according to an embodiment of the present disclosure;

FIG. 4A is a graph showing the transient-state-pure-tone amplitude, and FIG. 4B showing the amplitude of the input pure tone;

FIGS. 5A to 5I show graphs for the transient-state-pure-tone amplitude, the predicted pure-tone amplitude, and the filtered pure-tone amplitude according to an embodiment of the present disclosure when 1 kHz sound with constant amplitude is input;

FIG. 6 shows a graph of the filtered pure-tone amplitude when a complex tone is input;

FIG. 7 shows a graph of the filtered pure-tone amplitude when a complex tone which is different from FIG. 6 is input;

FIG. 8 is a flowchart showing a method for extracting a frequency of an input sound according to an embodiment of the present disclosure;

FIGS. 9A to 9F are drawings which show the result of the STFT, the frequencies of the input sounds, and the result of the DJ transform according to the present disclosure when pure tones are input;

FIGS. 10A to 10D are drawings which show the results of the DJ transform according to the present disclosure when the frequencies of the input pure tones are changed;

FIGS. 11A to 11D are drawings which show the results of the STFT when the frequencies of the input pure tones are changed;

FIGS. 12A to 12C are drawings which show the frequency components of the input signals, the results of DJ transform, and the results of the STFT when a flickering signal and a lasting signal are input;

FIGS. 13A to 13C are drawings which show the frequency components of an input sound, the results of the DJ transform and the STFT when 1 kHz and 2 kHz sounds are alternately input;

FIGS. 14A to 14C are drawings which show the results of the DJ transform and the STFT when a pure tone and a complex tone are input;

FIG. 15 shows a device for extracting a frequency of an input sound according to an embodiment of the present disclosure.

### DETAILED DESCRIPTION

The following description with reference to the accompanying drawings is provided to assist in a comprehensive understanding of various embodiments of the present disclosure.

Hair cells convert mechanical signals generated in the basement membrane into electrical signals and transfer the signals to the primary auditory cortex. Hair cells consist of about 3,500 inner hair cells and 12,000 external hair cells, and each hair cell reacts sensitively to the sound of its own natural frequency. This characteristic of hair cells is similar to a phenomenon occurred in a spring of which amplitude increases because of resonance when the spring receives an external force with a frequency that matches the natural frequency of the spring. Using this similarity, the present disclosure models the behavior of hair cells using a plurality of springs.

The human audible frequency is known to be in the range of 20˜20,000 Hz and the human voice frequency is known to be in the range of 80˜8,000 Hz. The frequency range covered in the field such as speech recognition is within 8 kHz. Considering the same, when used for a voice processing, the natural frequencies of the springs from 50 Hz to 8 kHz are classified by 1 Hz intervals, and 7,951 different types of springs can be used based on those natural frequencies. This means that the frequency resolution is 1 Hz unit. However, this is only an example, and widening the frequency range or increasing the resolution by using more springs is possible.

The behavior of a hair cell modeled by a spring can be represented as a differential equation of motion for driven harmonic oscillations. A sound corresponds to an external force made up of a combination of various sine waves which are applied to a spring. Each spring has its own natural frequency and draws its own motion trajectory by a series of sound samples. The motion trajectory of each spring can be obtained by calculating the solution of the differential equation of motion for driven harmonic oscillations using numerical analysis techniques such as the Runge-Kuta method.

Assume that ωᵢ is the natural frequency of a spring Sᵢ (1≤i≤N). The spring Sᵢ is used to model the response of a hair cell that are most sensitive to the sound of ωᵢ frequency among the hair cells constituting the human hearing system.

When the sound F₀ cos(ωt) is input, the reaction xᵢ(t) of the spring Sᵢ to the sound can be represented by the equation of motion of the following equation (1):

$$\frac{{d}^{2} {x}_{i}}{d {t}^{2}} + 2 ζ {ω}_{i} \frac{{dx}_{i}}{d t} + {ω}_{i}^{2} {x}_{i} = \frac{{F}_{0} cos ( ω t )}{m} \qquad ( 1 )$$

where xᵢ is the length of the spring which deviates from the balance point (displacement), and m is the mass of the object suspended in the spring. ζ is a damping ratio and when a friction coefficient is bᵢ,

$$ζ = \frac{{b}_{i}}{2 \sqrt{m {k}_{i}}} .$$

kᵢ is a spring constant. ωᵢ is the natural frequency of the spring when both ζ and Fᵢ are zero, and ωᵢ=\sqrt{kᵢ/m}.

Equation (1) is a differential equation with a general solution. When ζ<1, the solution is the same as the equation (2) below.

$${x}_{i} ( t ) = {A}_{i} {e}^{- {ζω}_{i} t} cos ( \sqrt{1 - {ζ}^{2}} {ω}_{i} t + {β}_{i} ) + \frac{{F}_{0}}{m {Z}_{i}} cos ( ω t + {ϕ}_{i} ) \qquad ( 2 )$$

where Aᵢ and βᵢ are determined by the initial conditions of the spring, and Zᵢ and φᵢ are as below:

$$\begin{matrix}{Z}_{i} = \sqrt{{( 2 {ω}_{i} ω ζ )}^{2} + {( {ω}_{i}^{2} - {ω}^{2} )}^{2}} & ( 3 ) \\ {ϕ}_{i} = arctan ( \frac{2 ω {ω}_{i} ζ}{{ω}^{2} - {ω}_{i}^{2}} ) + n π & ( 4 )\end{matrix}$$

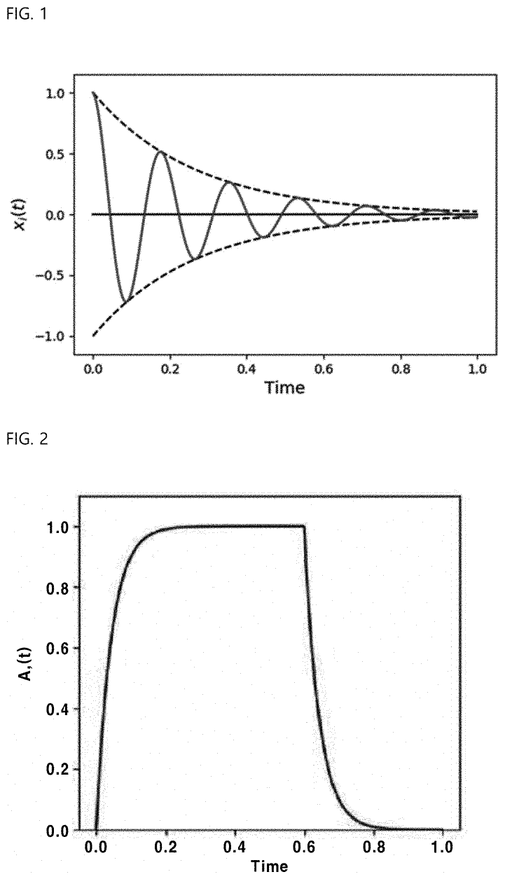

The integer n is specified so that φᵢ is between −180° and 0°. If F₀=0, the spring is subjected to periodically damping oscillation as shown in FIG. 1. If F₀>0 and the spring reaches a steady state after a certain period of time, the first term in the equation (2) disappears and the second term remains only so that the trajectory X_{i,s}(t) of the spring in a steady state follows the equation (5).

$${x}_{i , s} ( t ) = \frac{{F}_{0}}{m {Z}_{i}} cos ( ω t + {ϕ}_{i} ) \qquad ( 5 )$$

Consider a situation in which a sound having a frequency identical with the natural frequency ωᵢ of a spring Sᵢ in a stop state is applied to the spring as an external force. The behavior of the spring in the process of reaching a steady state is described by the equation (6) below.

xᵢ(t)=(1−e^{-ζω}^{ᵢ}^{t)}x_{i,s}(t) (6)

Therefore, the amplitude Aᵢ(t) of the spring gradually increases along the trajectory of

$${A}_{i} ( t ) = \frac{{F}_{0}}{m {Z}_{i}} ( 1 - {e}^{- ζ {ω}_{i} t} )$$

and finally becomes

$$\frac{{F}_{0}}{m {Z}_{i}} .$$

As the external force disappears at the point t₀, the amplitude of the spring gradually decreases to zero. This corresponds F₀=0 in the equation (2), and the amplitude change in this process follows the equation below.

Aᵢ(t)=Aᵢ(t₀)e^{-ζω}^{ᵢ}^{(t-t}^{₀}⁾ (7)

FIG. 2 is an example of a graph showing the changes in amplitude of a spring when an external force is applied and disappears.

According to the embodiments of present disclosure, two methods for extracting the frequency and amplitude of the input sound are proposed based on the behavior of the spring modeled as hair cells.

### Method I for Extracting the Frequency and Amplitude of the Input Sound

1. In a Steady State

(1) Extraction of Frequency

Based on the characteristic that a resonating spring oscillates with a greater amplitude than other springs, a frequency of an input sound can be extracted.

Given a pure sound F₀ cos(ωt), an amplitude of a spring Sᵢ in a steady state becomes

$$\frac{{F}_{0}}{m {Z}_{i}}$$

by the equation (5). If the mass m of the object suspended in each spring is equal to each other, the spring with the greatest amplitude is the spring having the minimum Zᵢ. The relationship between the natural frequency ωᵢ of the spring and the frequency ω of pure tone can be obtained by differentiating Equation (3) with respect to ωᵢ, and the result is as follows:

ω=ωᵢ\sqrt{1−2ζ²} (8)

where ζ<1/\sqrt{2}. If ζ is a small value near zero, then ω≈ωᵢ. For example, ζ could be 0.001. In order to find out the spring having the greatest amplitude, a numerical analysis method such as Runge-Kuta, which solves differential equations, is used. Given a pure sound F₀ cos(ωt), the displacement xᵢ(t) and the velocity vᵢ(t) of each spring Sᵢ which corresponds to the solution of equation (1) are calculated using the numerical analysis method. Since an energy of each spring is the sum of a kinetic energy and a potential energy, the energy of spring Sᵢ can be obtained by equation (9).

Eᵢ=1/2kᵢxᵢ²+1/2mvᵢ² (9)

The energy of the spring that has reached a steady state maintains a constant value. Thus, the displacement xᵢ at the time when the velocity vᵢ is 0 becomes the amplitude of the spring Sᵢ. Therefore, the amplitude Aᵢ of spring Sᵢ in a steady state can be calculated by the equation below:

$${A}_{i} = \sqrt{\frac{2 {E}_{i}}{{k}_{i}}} \qquad ( 10 )$$

The spring having the largest amplitude among the extracted amplitudes of the springs is the resonating spring. Therefore, it is possible to obtain the frequency of an input pure tone by using both the natural frequency ωi of the spring having the largest amplitude and the equation (8).

(2) Extraction of Amplitude

In a steady state, the trajectory of the spring is given by the equation (5). Therefore, the relationship between an energy of a spring in a steady state, E_{i,s}, and an amplitude F₀ of a given pure tone can be represented by the equation (11).

$${E}_{i , s} = \frac{1}{2} {{k}_{i} ( \frac{{F}_{o}}{m {Z}_{i}} )}^{2} \qquad ( 11 )$$

In addition, the energy in a steady state, E_{i,s}, can be obtained by putting the displacement xᵢ and the velocity vᵢ in the steady state, which are obtained by solving the equation (1) with the numerical analysis method, into the equation (9). Therefore, the amplitude F₀ of a given pure tone becomes as below:

$${F}_{o} = m {Z}_{i} \sqrt{\frac{2 {E}_{i , s}}{{k}_{i}}} \qquad ( 12 )$$

The natural frequency ωᵢ of the spring that resonates with an external force is almost the same with the frequency of the external force. Therefore, if putting ω≈ωᵢ into the equation (3), then Zi=2ωᵢ²ζ. If putting both of this result and ωᵢ=\sqrt{kᵢ/m} into the equation (12), the amplitude F₀ of the input pure tone can be calculated by the equation (13).

F₀=2ζωᵢ\sqrt{2mE_{i,s}} (13)

2. In a Transient State

(1) Extraction of Frequency

Assume that a pure tone F₀ cos(ωt) is given over a time interval [tₐ, t_{b}]. All springs start to move in an initial state where both displacements and velocities are zero. Using the numerical analysis technique, the energies of the springs are calculated at each time point, and the calculated results are put into the equation (10) to obtain the amplitudes of the springs at each time point. After that, the natural frequency of the spring having the largest amplitude is substituted into the equation (8) to calculate the frequency of the given pure tone.

(2) Extraction of Amplitude

Assume that an energy of a resonating spring Sᵢ found by the numerical analysis is Eᵢ(t). The amplitude Aᵢ(t) of a spring Sᵢ at time t can be calculated from Eᵢ(t) using the equation (10).

According to the general solution of the equation (1), the amplitude Aᵢ(t) of the spring Sᵢ resonating with a given sound wave follows the trajectory of the equation (6), so that the spring Sᵢ follows the trajectory of Aᵢ(t)=(1−e^{-ζω(t-t}^{ₐ}⁾)A_{i,s} in a time interval [tₐ, t_{b}] starting from the initial state until it reaches the steady state. Here, A_{i,s} is the amplitude of the spring when it reaches the steady state. We call it an expected steady-state amplitude.

The energies Eᵢ(t1) and Eᵢ(t2) at two time points t₁, t₂ within the time interval [tₐ, t_{b}] can be obtained with the numerical analysis method. Therefore, the amplitudes Aᵢ(t₁) and Aᵢ(t₂) can be obtained by substituting these results into the equation (10). The expected steady-state amplitude, A_{i,s}, can be obtained by putting the result into Aᵢ(t)=(1−e^{-ζω(t-t}^{ₐ}⁾)A_{i,s}, and the result is as the equation below:

$${A}_{i , s} = \frac{{A}_{i} ( {t}_{2} ) - {A}_{i} ( {t}_{1} ) {e}^{- ζ ω ( {t}_{2} - {t}_{1} )}}{1 - {e}^{- ζ ω ( {t}_{2} - {t}_{1} )}} \qquad ( 14 )$$

Next, regarding the case where the frequency is the same but the volume of the sound changes, assume that the amplitude of the sound given at the point t_{c} has changed from F₁ to F₂. Let A_{c} be the amplitude of a spring at the time point t_{c} and let Aₛ be the amplitude of a spring at the time the spring will have approached a steady state after the external force changes to F₂. The behavior of the amplitude over time can be described by the following equation.

A(t)=Aₛ+(A_{c}−Aₛ)e^{-ζω(t-t}^{_{c}}⁾ (15)

Given the amplitudes A(t₁) and A(t₂) at two time points t₁ and t₂ within the time interval that the amplitude changes from A_{c} to Aₛ, it can be seen that the obtained Aₛ is the same as Equation (14).

For example, consider the case where the external force F₂=0 at the time point t_{c}. When the external force disappears, the energy of the spring decreases exponentially according to the equation (7). Namely, the measured amplitude of the spring after ΔT seconds from the time when the external force disappears will be A(t_{c}+ΔT)=A(t_{c})e^{-ζωΔt}. Putting this measurement result into the equation (14) makes Aₛ=0, and it means the external force has disappeared.

Therefore, the expected steady-state amplitude, Aₛ, can be obtained by measuring the energy of the spring more than once. Using equation (10) which represents the correlation between amplitude and energy, the energy in the steady state, Eₛ, can be calculated and consequently the amplitude F₀ of a given pure tone can be calculated using the equation (13).

Since the force applied to the spring is in the form of a periodic function, the energy does not increase uniformly within a period of a transient state. Considering this characteristic, when selecting the two time points t₁ and t₂ described above, the time interval is made to be the same with the period.

In this regard, it may not be able to select two time points of which a time difference between them is one period due to the relationship between the sampling rate of the sound data and the natural frequency of the spring. In this case, an error may occur, and two methods can be used to correct this error.

The first method is to select an adjacent sample which shows a less difference with a period. When the position S₁ of a sample and the period T of an audio data are given, the position S₂ of the second sample is calculated as [S₁+sampling rate×T+0.5]. The expected steady-state amplitude, Aₛ, is calculated by putting the time information of the two points and the amplitudes at the two points into the equation (14).

The second method uses a linear regression analysis. After extracting the amplitude at several points and putting the extracted data into the equation (15), the expected steady-state amplitude, Aₛ, is calculated by the linear regression analysis.

Based on the above theoretical background, a method for extracting a frequency of an input sound can be proposed as below.

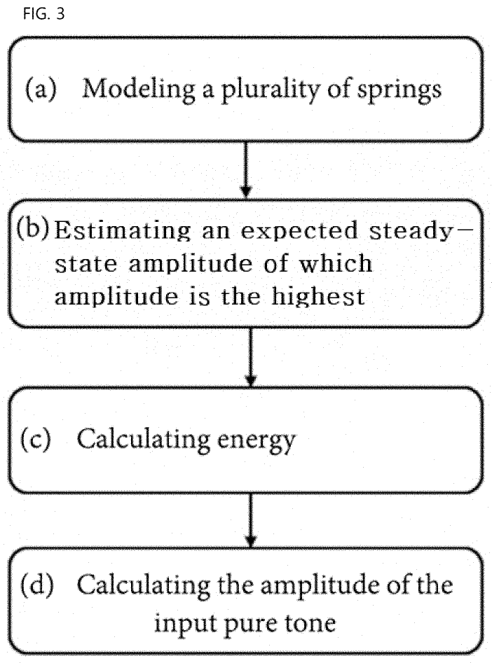

Referring FIG. 3, a method, of which each step is performed by a computer, for extracting a frequency of an input sound according to an embodiment of the present disclosure may comprise the steps of:
(a) modeling a plurality of springs which have natural frequencies different from each other and oscillate in accordance with the input sound;
(b) estimating an expected steady-state amplitude, A_{i,s}, of the spring of which amplitude Aᵢ(t) is the highest among the plurality of modeled springs;
(c) calculating energy E_{i,s} of said spring of which amplitude is the highest based on the expected steady-state amplitude, A_{i,s}; and
(d) calculating the amplitude F0 of the input sound based on said energy Ei,s.

The step (a) may comprise the steps of: measuring displacements xᵢ(t) and velocities vᵢ(t) at time points for each of the plurality of springs (see the equation 1); calculating energy Eᵢ(t) at each time point for each of the plurality of springs based on the displacements and the velocities (see the equation 9); and calculating an amplitude Aᵢ(t) of each of the plurality of springs based on the energies Eᵢ(t) (see the equation 10).

The step (b) can be calculated with the equation (14).

In the step (b), said expected steady-state amplitude, A_{i,s}(t), can be calculated based on the amplitudes at two different time points within a duration of the input sound.

A difference between the two different time points can be a period of the natural frequency of the corresponding spring.

When one of the two time points is t₁, a sampling rate of the input sound is SR, and the period of the natural frequency of the corresponding spring is T, the other t₂ of the two time points can be calculated by means of the equation below.

t₂=[t₁+SR×T+0.5]

The number of the plurality of springs N may be determined based on a range and a resolution of the frequency to be extracted.

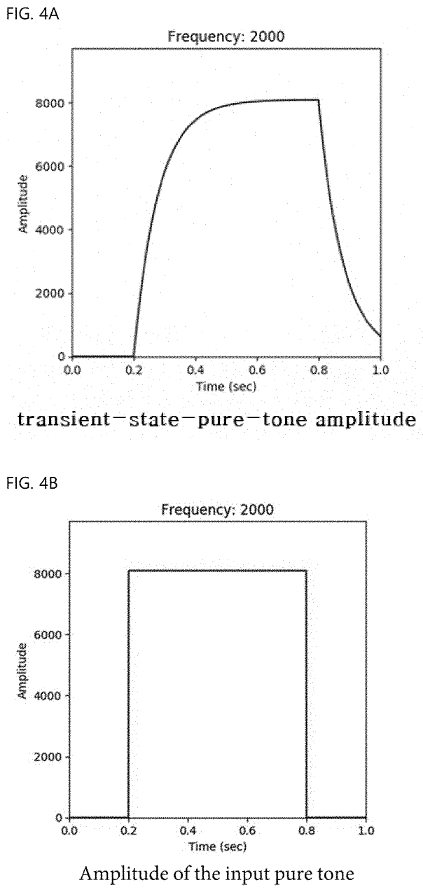

FIGS. 4A to 4C are graphs representing the experimental results according to embodiments of the present disclosure.

FIG. 4A shows the result obtained by putting the energy E₂₀₀₀(t) of a spring, of which natural frequency is 2 kHz over time when a pure tone having a frequency of 2 kHz with a constant amplitude is input between 0.2 and 0.8 seconds, into the equation (13). This result is called a transient-state-pure-tone amplitude. The transient-state-pure-tone amplitude is an amplitude of the input pure tone which is calculated under the assumption that there is no change in the energy of the spring. As time goes by, the energy of the spring reaches a steady state. Therefore, as shown in FIG. 4A, the transient-state-pure-tone amplitude gradually reaches a steady state, and the amplitude at this time corresponds to the amplitude Fₘ(t) of the input pure tone. Here, m indicates a natural frequency of a spring.

FIG. 4B shows the amplitude Fₘ(t) of the input pure tone that is obtained by putting the measured amplitude of the spring into the equation (14) to obtain the expected steady-state amplitude of the spring, A_{m,s}(t), and applying the results to the steps (c) and (d) of the frequency extraction method above. As shown in FIG. 4B, the amplitude of the input pure tone is extracted from the starting point of the pure tone.

### Method II for Extracting the Frequency and Amplitude of the Input Sound

According to the method I for extracting the frequency and amplitude of the input sound described above, if the input sound is a pure tone, the frequency and amplitude of the input sound can be effectively extracted.

Now, assume that there are n types of pure tones constituting a complex tone F(t)=ΣⱼFⱼ cos(ωⱼt+φⱼ). If n=1, the pure tone of a given sound can be found by selecting the spring having the largest amplitude among the springs. However, if n>1, it is difficult to find out pure tones constituting the complex tone by selecting top n springs in the order of amplitude.

The first reason is that the amplitude of a spring of which the frequency is adjacent to the spring having the largest amplitude could be greater than the amplitude of the spring which resonates with other pure tones constituting the complex tone. The second reason is that, as shown in the trajectory after 0.8 seconds in FIG. 2, even though the external force disappears, it takes time until the amplitude of the spring reaches 0, so the amplitude of the sound that does not exist anymore could be greater than the amplitude of other pure tones.

Accordingly, in this embodiment, instead of finding the local maximum value among the spring amplitudes at each time point, a method of finding the local maximum value from the results of multiplying an expected steady-state amplitude and a transient-state-pure-tone amplitude is proposed.

### 1. Expected Steady-State Amplitude and Filtered Pure-Tone Amplitude

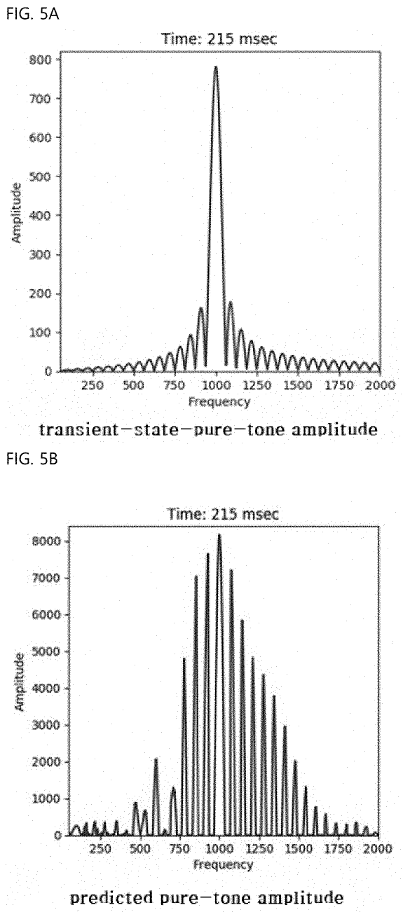

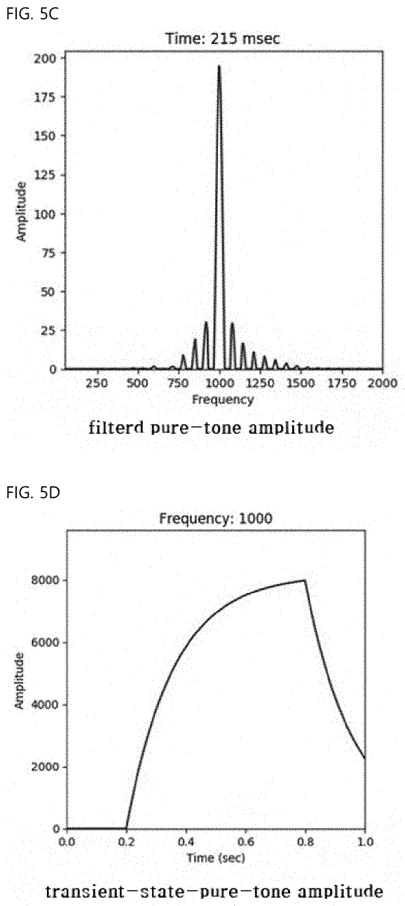

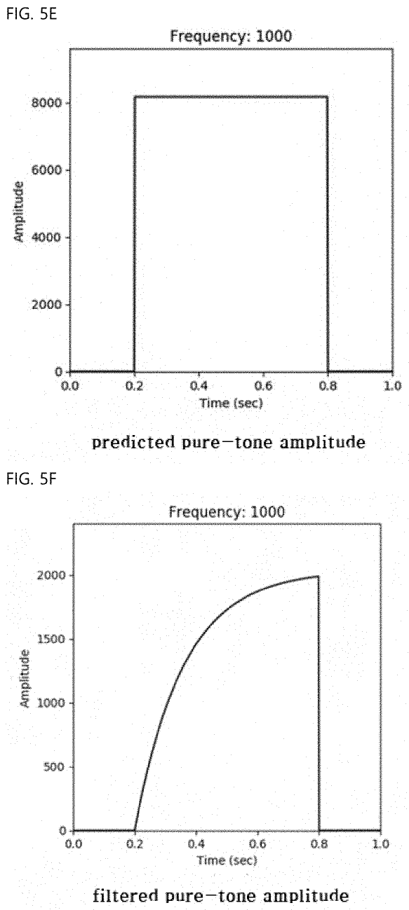

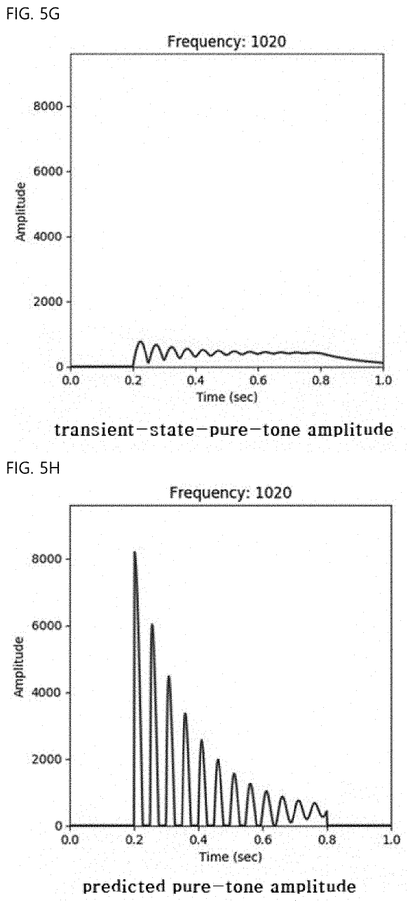

First, in order to extract the pure tones constituting a complex tone, the amplitude Aᵢ(t) of each spring Sᵢ is calculated by applying the step (a) of the method I to each spring for extracting the frequency of an input sound. FIG. 5A shows the amplitudes of springs of which natural frequencies are around 1 kHz as a result measured at 215 milliseconds when a sound having a frequency of 1 kHz with a constant amplitude starts at 200 milliseconds. FIG. 5A shows that the amplitude of the spring that does not resonate is lower than that of the spring that resonates.

Next, an expected steady-state amplitude, A_{i,s}(t), is calculated by applying the step (b) of the method I for extracting the frequency of an input sound to the amplitude Aᵢ(t) of each spring Sᵢ. However, the equation (14) which calculates the expected steady-state amplitude is an equation derived from the equation (7) which describes the behavior of a resonating spring. Therefore, high amplitudes could be resulted even at the frequencies away from the resonant frequency as in FIG. 5B.

Accordingly, the following steps are performed. The third step is to calculate a transient-state-pure-tone amplitude, F_{i,t}(t), by putting the amplitude Aᵢ(t) of the spring Sᵢ into the equation (13). In addition, a predicted pure-tone amplitude, F_{i,s}(t), is calculated by applying steps (c) and (d) of the method I for extracting the frequency of the input sound to the expected steady-state amplitude, A_{i,s}(t).

As the final step, a filtered pure-tone amplitude, F_{i,p}(t), is calculated by multiplying the transient-state-pure-tone amplitude, F_{i,t}(t), with the predicted pure-tone amplitude, F_{i,s}(t), as in F_{i,p}(t)=F_{i,t}(t)×F_{i,s}(t). Additionally, the result of multiplication of the amplitudes may be divided by the maximum amplitude of the sound in order not to exceed 1 but to be normalized. For example, if the sound is expressed as a 16-bit integer, the result is divided by 32,767.

A filtered pure-tone amplitude has the characteristic that 1) the amplitude becomes 0 when the sound disappears, and 2) the amplitudes of frequencies away from a resonant frequency in the frequency domain are low.

FIG. 5C shows the filtered pure-tone amplitude, which is the result of multiplication of the amplitudes in FIGS. 5A and 5B with respect to the same frequency. FIGS. 5D to 5F show the transient-state-pure-tone amplitude, the predicted pure-tone amplitude, and the filtered pure-tone amplitude obtained by the spring with a natural frequency of 1 kHz, respectively. Especially, it is shown that, after the input sound disappears at 0.8 seconds, the amplitude in FIG. 5D remains not to be zero, but the amplitudes in FIGS. 5E and 5F become zero. FIG. 5G to 51 show the results for the spring with the natural frequency of 1,020 Hz. Apparently, the filtered pure-tone amplitude, F_{1020,p}(t), is very small compared to the filtered pure-tone amplitude, F_{1000,p}(t), of the resonating spring of FIG. 5F.

2. Finding a Pure Tone from Local Maximum Values

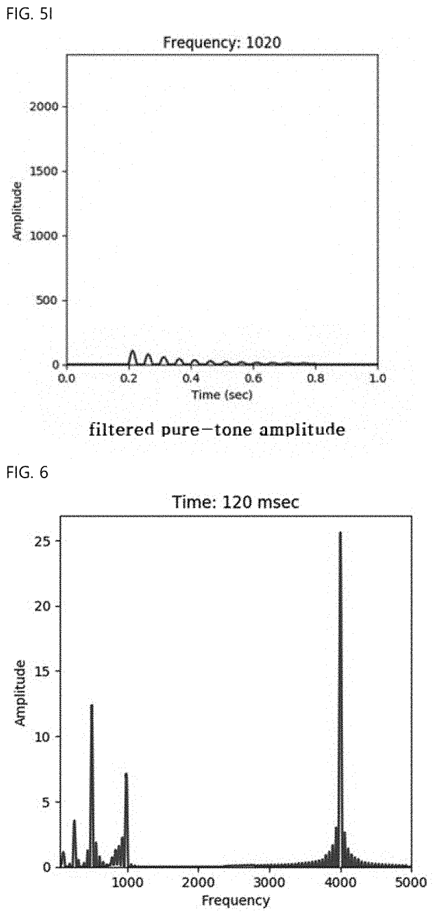

FIG. 6 is a graph showing frequency vs. filtered pure-tone amplitude of a complex tone composed of five pure tones of 100 Hz, 250 Hz, 500Hz, 1 kHz, and 4 kHz. As shown in FIG. 6, if frequency intervals of the sounds constituting the complex tone are broad, each pure tone frequency generates a local maximum value among local maximum values in a frequency. Using these characteristics, several local maxima are obtained from a frequency vs. amplitude graph obtained by using the filtered pure-tone amplitude. Then the local maxima of those several local maxima are obtained again. Finally, frequencies corresponding to the local maxima are regarded as frequencies of the pure tones constituting the complex tone.

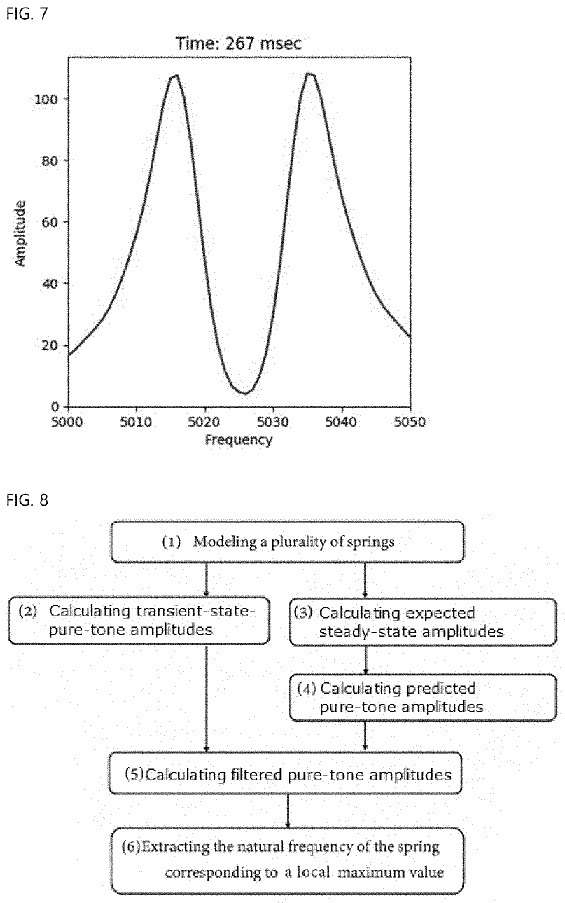

However, if the frequency interval is narrow, no local maximum might exist between two adjacent local maxima. FIG. 7 is a part of the graph for frequency vs. filtered pure-tone amplitude of a complex tone composed of five pure tones of 112 Hz, 181 Hz, 1,034 Hz, 5,017 Hz, and 5,034 Hz. It shows that no local maximum exists between the two local maxima that are generated by the two adjacent frequencies, 5,017 Hz and 5,034 Hz. The characteristic of this case is that the frequency interval is narrow and the two filtered pure-tone amplitudes are similar. Therefore, if the frequency difference between of two adjacent local maxima in filtered pure-tone amplitudes is within a certain width (e.g., the bandwidth of a high-amplitude frequency) and the ratio of those filtered pure-tone amplitudes is equal to or greater than a certain level (e.g. 0.5), both frequencies are treated as the frequencies of pure tones constituting the complex tone.

Based on the theoretical background described above, the following method for extracting the frequency of the input sound is proposed.

Referring FIG. 8, a method, of which each step is performed by a computer, for extracting a frequency of an input sound according to an embodiment of the present disclosure comprises the steps of:
(1) modeling a plurality of springs, each spring Sᵢ (1≤i≤N) of which has natural frequencies ωᵢ, being different from each other, and oscillates according to the input sound;
(2) calculating transient-state-pure-tone amplitudes of the plurality of modeled springs at each time t, {F_{i,t}(t)|1≤i≤N}, based on displacements and velocities of the modeled springs;
(3) calculating expected steady-state amplitudes of the plurality of modeled springs at each time t, {A_{i,s}(t)|1≤i≤N};
(4) calculating predicted pure-tone amplitudes, {F_{i,s}(t)|1≤i≤N}, based on the expected steady-state amplitudes at each time t, {A_{i,s}(t)|1≤i≤N};
(5) calculating filtered pure-tone amplitudes at each time t, {F_{i,p}(t)|1≤i≤N}, by multiplying the transient-state-pure-tone amplitude, F_{i,t}(t), with the predicted pure-tone amplitude, F_{i,s}(t), for each spring Sᵢ; and
(6) extracting natural frequencies of the springs, each filtered pure-tone amplitude of which is a local maximum in a frequency range.

The step (1) may comprise the steps of: measuring displacements xᵢ(t) and velocities vᵢ(t) at different time points for each of the plurality of springs (see the equation 1); calculating an energy Eᵢ(t) at each time point for each of the plurality of springs based on the displacements xᵢ(t) and the velocities vᵢ(t) (see the equation 9); and calculating an amplitude Aᵢ(t) at each time point for each of the plurality of springs based on the energy Eᵢ(t) (see the equation 10).

The equation 13 can be used in the step (2), the equation 14 can be used in the step (3), and the equation 13 can be used in the step (4).

The number of the plurality of springs, N, may be determined based on a range and a resolution of the frequencies to be extracted.

In the step (3), the expected steady-state amplitudes, A_{i,s}(t), can be calculated based on the amplitudes at two time points within a duration of the input sound.

In the step (3), the expected steady-state amplitudes, A_{i,s}(t), can be calculated by means of the equation below:

$${A}_{i , s} = \frac{{A}_{i} ( {t}_{2} ) - {A}_{i} ( {t}_{1} ) {e}^{- ζ ω ( {t}_{2} - {t}_{1} )}}{1 - {e}^{- ζ ω ( {t}_{2} - {t}_{1} )}}$$

where t₁ and t₂ are the two different time points within the duration of input sound, t₂>t₁, Ai(t₁) is an amplitude of any spring among the plurality of springs at t₁, Ai(t₂) is an amplitude of said spring at t₂, ζ is a damping ratio of said spring, and ω satisfies the equation ω=ωᵢ\sqrt{1−2ζ²}, where ωᵢ is the natural frequency of said spring.

A difference between the two different time points can be a period of the natural frequency of the corresponding spring.

When one of the two time points is t₁, a sampling rate of the input sound is SR, and a period of the natural frequency of the corresponding spring is T, the other t₂ of the two time points is calculated by the equation below.

t₂=[t₁+SR×T+0.5]

Hereinafter, the experimental results according to the present embodiment will be described. To show the performance of the DJ transform according to the present disclosure, the results of the DJ transform and that of the STFT were compared. In the DJ transform, 7,951 springs of which natural frequencies are from 50 Hz to 8,000 Hz were used, respectively. The frequency interval of springs was 1 Hz. A 25 milliseconds window was used for the STFT.

The DJ transform was performed in an NVIDIA M40 GPU environment with 3,072 cores and 12 GB of memory and was implemented using the C language API of Cuda Toolkit 8.0. It took about 0.6 seconds to do the DJ transform for a 1 second audio data.

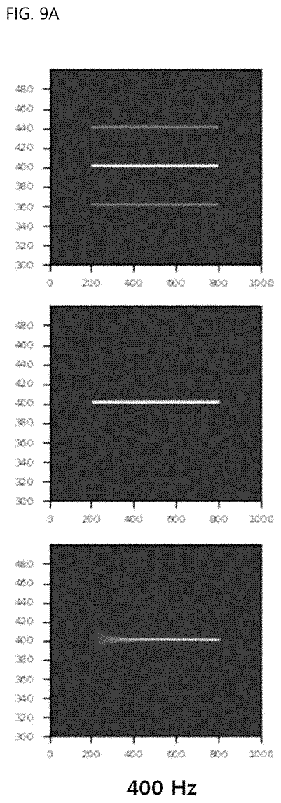

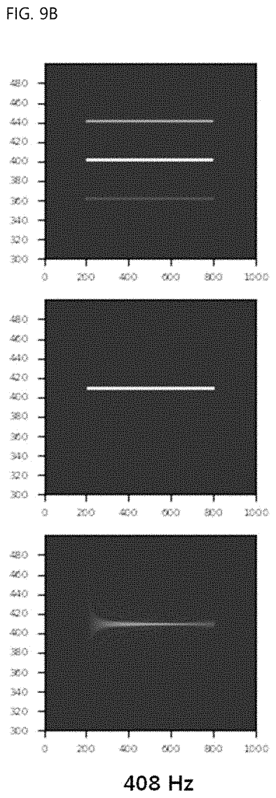

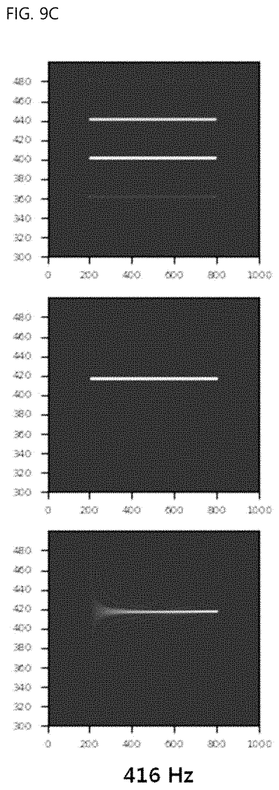

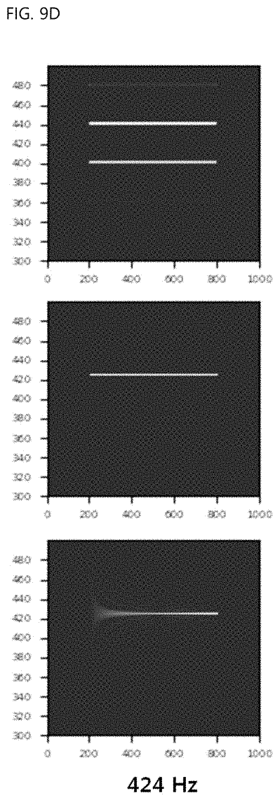

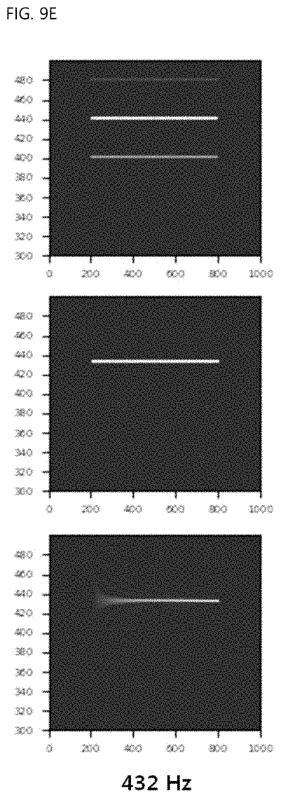

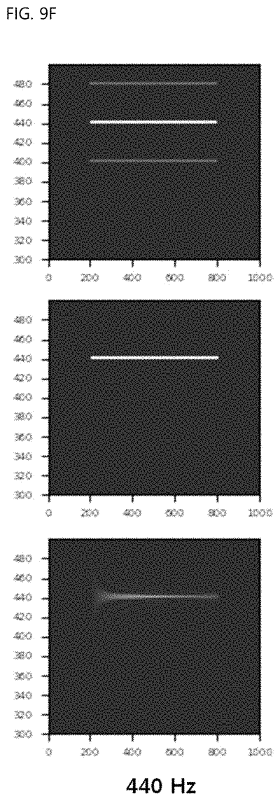

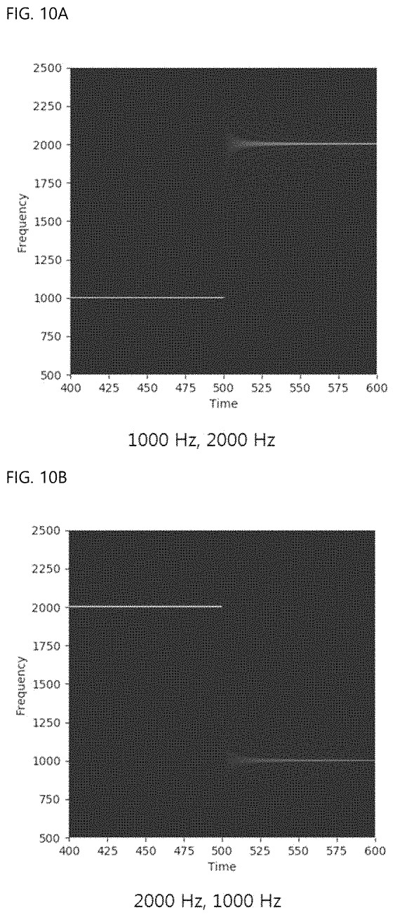

FIGS. 9A to 9F are diagrams showing the results of the STFT and the DJ transform in terms of the frequency resolution. In FIGS. 9A to 9F, the first rows show the results of the STFT, the second rows show the frequencies of the input sounds, and the third rows show the results of the DJ transform according to an embodiment of the present disclosure.

As shown in FIGS. 9A to 9F, the frequency resolution of the STFT result was 40 Hz. In addition, when the frequencies of pure tones were 400 Hz, 408 Hz, and 416 Hz, the peak was output at 400 Hz, and when the frequencies of pure tones were 424 Hz, 432 Hz, and 440 Hz, the peak was output at 440 Hz. However, the DJ transform results were matched with all the frequencies of pure tones. That means the frequency resolution of the DJ transform result was 1 Hz.

Three experiments were conducted to compare the results of the DJ transform with the STFT in terms of temporal resolution.

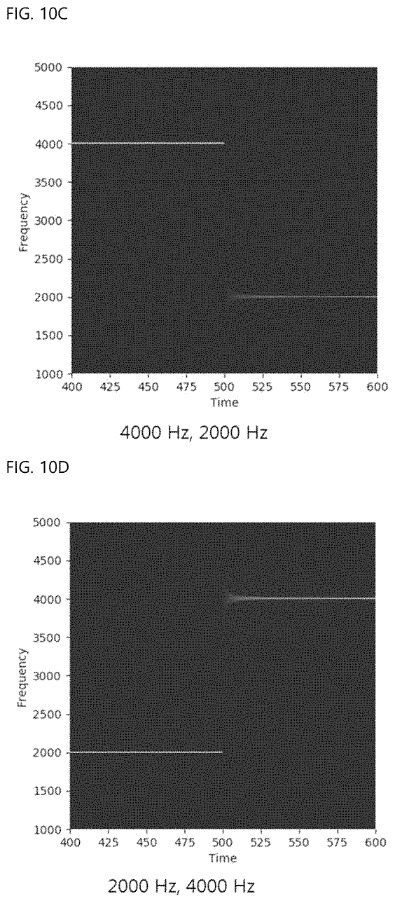

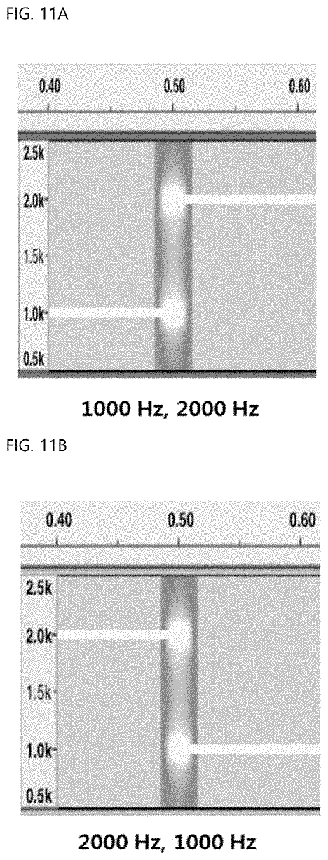

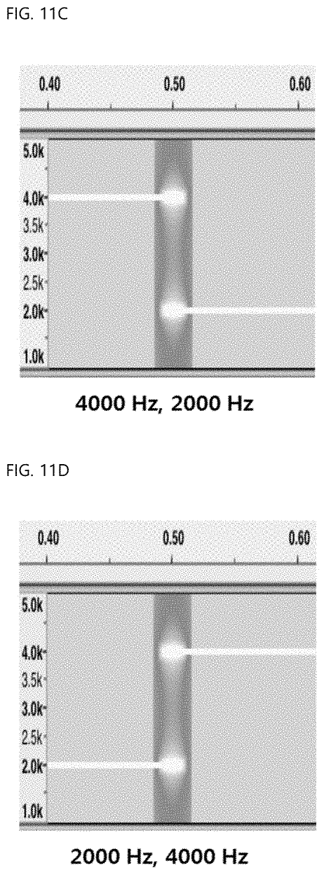

The first experiment was to check the frequency extracted at the time point where an input frequency changes. FIG. 10A shows a result of extracted frequencies by the DJ transform when a 1 kHz pure tone had been input for 500 milliseconds and a 2 kHz pure tone was input just after 500 milliseconds, FIG. 10B shows a result of extracted frequencies by the DJ transform when a 2 kHz pure tone had been input for 500 milliseconds and a 1 kHz pure tone was input just after 500 milliseconds, FIG. 10C shows a result of extracted frequencies by the DJ transform when a 4 kHz pure tone had been input for 500 milliseconds and a 2 kHz pure tone was input just after 500 milliseconds, and FIG. 10D shows a result of extracted frequencies by the DJ transform when a 2 kHz pure tone had been input for 500 milliseconds and a 4 kHz pure tone was input just after 500 milliseconds. Obviously, FIGS. 10A to 10D show that the boundaries between the two frequencies were at 500-milliseconds. Specifically, until 500 milliseconds, the frequencies of 1 kHz, 2 kHz, 4 kHz and 2 kHz of the input pure tones were clearly displayed, and immediately after 500 milliseconds, the frequencies of 2 kHz, 1 kHz, 2 kHz and 4 kHz of the changed pure tone were displayed with about 10% error only. However, in the STFT results shown in FIGS. 11A to 11D, two frequencies are simultaneously extracted on the 500-millisecond boundary.

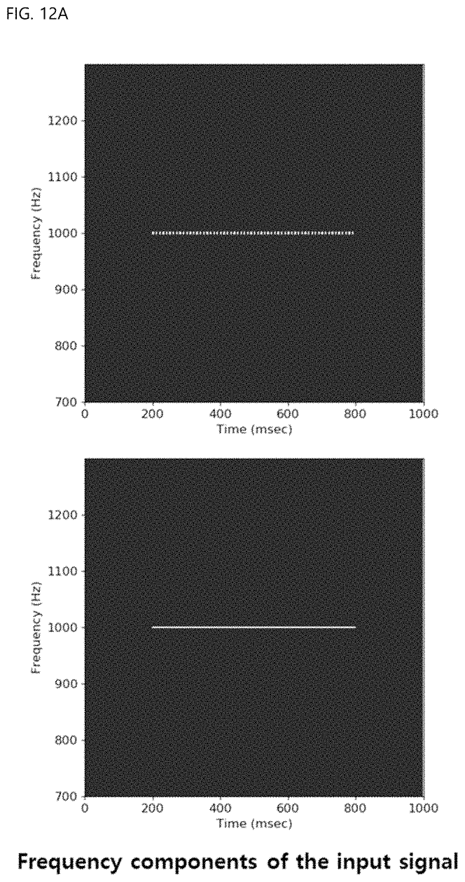

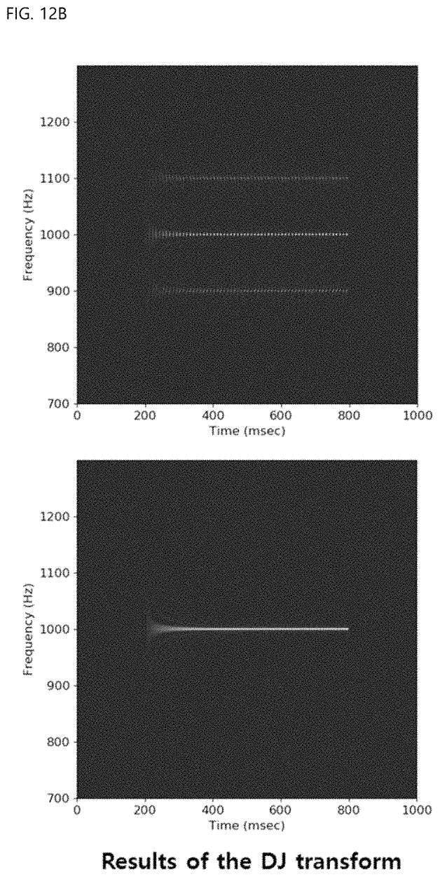

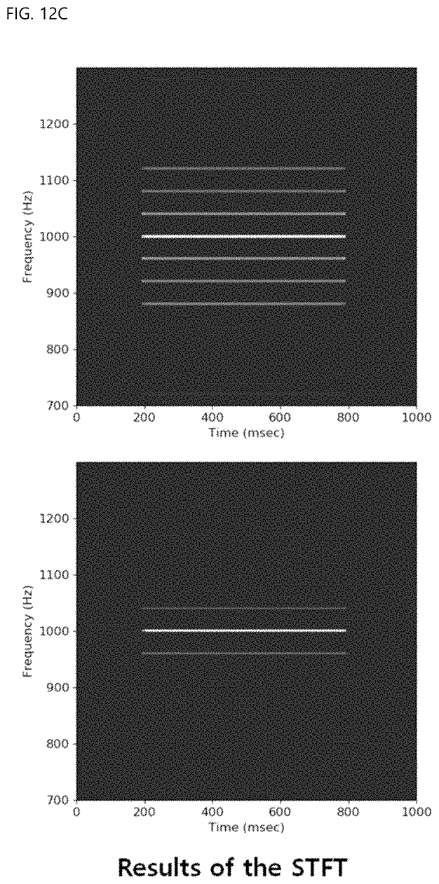

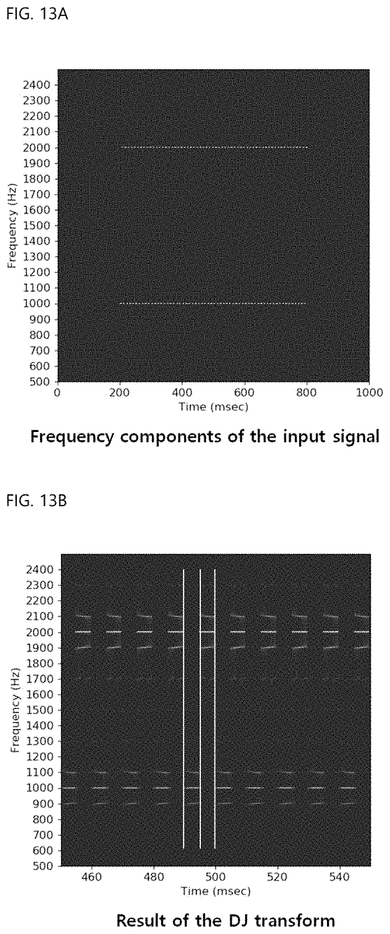

The second experiment is to extract frequencies from the sounds that appear and disappear rapidly. The first rows of FIGS. 12A to 12C show the frequency extraction results when a 1 kHz pure tone is generated for 5 milliseconds, and silent for the next 5 milliseconds from 200 milliseconds to 800 milliseconds (when a flicker signal is repeatedly input). The second rows show the results when a 1 kHz pure tone continuously is input from 200 milliseconds to 800 milliseconds (when a continuous signal is input). FIG. 12A is for the frequency components of the input sound over time, FIG. 12B is for the DJ transform results, and FIG. 12C is for the STFT result.

In FIG. 12B showing the results of DJ transform, the repeated flicker signal results in a broken line while the continuous signal results in a solid line thereby two signals are distinguished apparently. On the other hand, the results of the STFT shown in FIG. 12C show a solid line at 1 kHz, therefore, the distinction between the flicker signal and the continuous signal is not clear.

The upper drawing in FIG. 12B shows relatively weak broken lines at 1.1 kHz and 0.9 kHz. These lines are interpreted as the result of 100 Hz signal due to the repeated input of every 10 milliseconds cycle. On the other hand, in the STFT result, solid lines appear at 0.88 kHz, 0.92 kHz, 0.96 kHz, 1.04 kHz, 1.08 kHz and 1.12 kHz when looking at the upper drawing in FIG. 12C. It is conjectured that the reason the STFT result occurs is because 0.9 kHz and 1.1 kHz frequency components are generated by the 100 Hz signal and those components are represented by 40 Hz intervals due to the 40 Hz frequency resolution of the STFT.

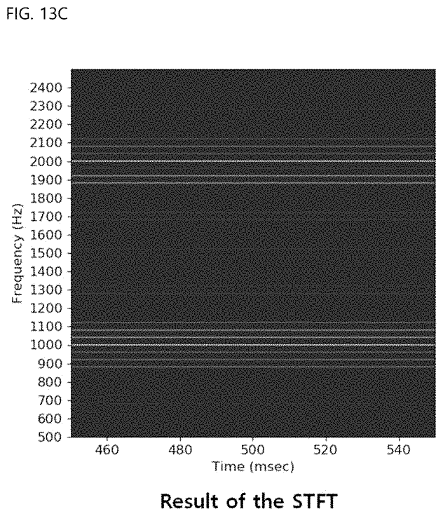

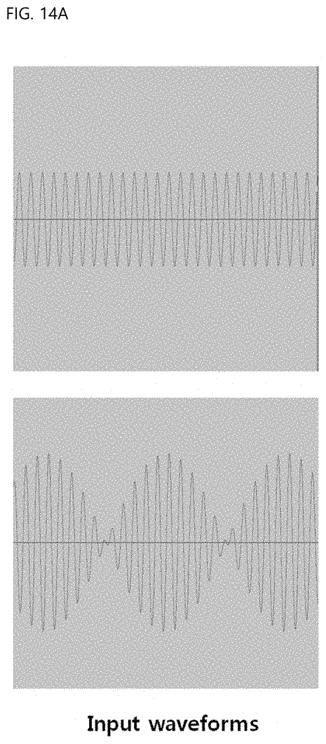

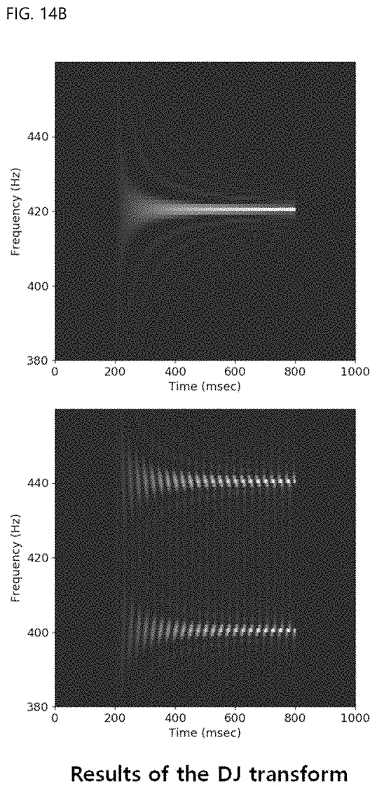

The third experiment is an extension of the second experiment, which shows the results in frequency extraction when a 1 kHz and a 2 kHz pure tones are alternately generated for 5 milliseconds from 200 milliseconds to 800 milliseconds (FIGS. 13A to 13C). FIG. 13B shows that the DJ transform produces the 1 kHz pure tone and the 2 kHz pure tone that are clearly separated in 5 milliseconds units. On the other hand, when the STFT is used, boundaries between the pure tones are not distinguishable as shown in FIG. 13C.

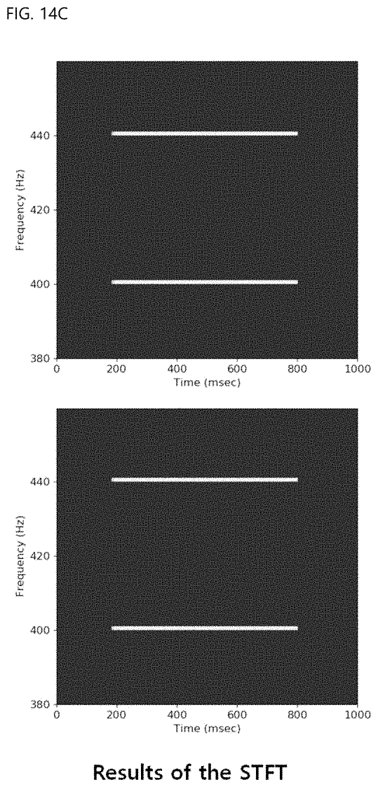

The first rows of FIGS. 14A to 14C show the input waveform, the result of the DJ transform, and the result of the STFT when a 420 Hz pure tone is input, and the second rows show the input waveform, the DJ transform result, and the STFT result when a complex tone composed of 400 Hz and 440 Hz is input. FIG. 14A shows input waveforms, and FIGS. 14B and 14C show the DJ transform results and the STFT results, respectively.

As can be seen in FIGS. 14B and 14C, the DJ transform extracts 420 Hz frequencies from a pure tone, and 400 Hz and 440 Hz frequencies from a complex tone. On the other hand, there is little difference between the results extracted from both pure tones and the complex tone with the STFT.

Since the complex tone is composed of 400 Hz and 440 Hz, the amplitude fluctuates in a 40 Hz cycle as shown in the bottom of FIG. 14A. On the other hand, as in the bottom of FIG. 14B, the DJ transform well reflects the characteristic of the amplitude fluctuation.

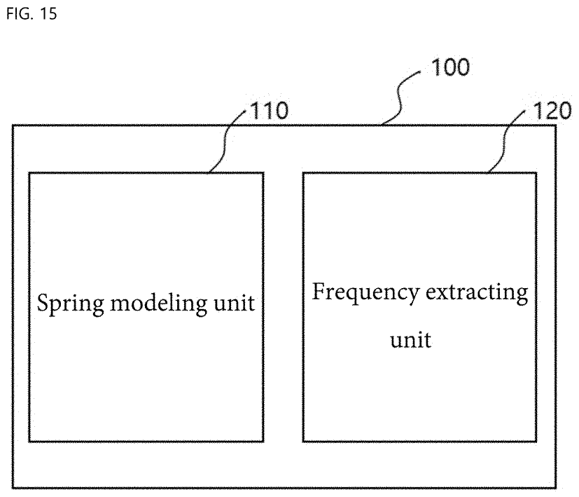

FIG. 15 shows a device for extracting a frequency of an input sound according to an embodiment of the present disclosure.

The device for extracting a frequency of an input sound according to an embodiment of the present disclosure may include a spring modeling unit 110 and a frequency extracting unit 120.

The spring modeling unit 110 calculates the displacements and velocities of a plurality of springs using the equations (1), (9), and (10). The spring modeling unit 110 may include threads corresponding to the number of a plurality of springs, and each thread may correspond to each spring.

The frequency extraction unit 120 extracts the frequency according to the steps (b) to (d) of the method I for extracting the frequency of an input sound based on the displacements and velocities calculated by the spring modeling unit 110. Or, the frequency extracting unit 120 extracts a frequency according to the steps (2) to (6) of the method II for extracting the frequency of an input sound based on the displacements and velocities calculated by the spring modeling unit 110.

Although the present disclosure has been described in detail through preferred embodiments, the present disclosure is not limited thereto, and various changes and applications can be made without departing from the technical spirit of the present disclosure, which is obvious to a person skilled in the art. Therefore, the scope of protection for the present disclosure should be interpreted by the following claims, and all technical ideas within the scope equivalent thereto should be interpreted as being included in the scope of the present disclosure.

What is claimed is:

1. A method, of which each step is performed by a computer, for extracting a frequency of an input sound comprising the steps of:
modeling a plurality of springs which have natural frequencies different from each other and oscillate according to an input sound;
calculating transient-state-pure-tone amplitudes of the plurality of modeled springs;
calculating expected steady-state amplitudes of the plurality of modeled springs;
calculating predicted pure-tone amplitudes based on the expected steady-state amplitudes;
calculating filtered pure-tone amplitudes by multiplying the transient-state-pure-tone amplitudes with the predicted pure-tone amplitudes; and
extracting the natural frequency of the spring which corresponds to a local maximum value among the filtered pure-tone amplitudes.

2. The method according to claim 1, wherein said expected steady-state amplitude is calculated based on the amplitudes at least two time points within a duration of the input sound.

3. The method according to claim 1, wherein said expected steady-state amplitude (A_{i,s}) is calculated by the equation below:
$${A}_{i , s} = \frac{{A}_{i} ( {t}_{2} ) - {A}_{i} ( {t}_{1} ) {e}^{- ζ ω ( {t}_{2} - {t}_{1} )}}{1 - {e}^{- ζ ω ( {t}_{2} - {t}_{1} )}}$$
where t₁ and t₂ are two different time points within a duration of the input sound, t₂>t₁,
Ai(t₁) is an amplitude of any spring among the plurality of springs at t₁,
Ai(t₂) is an amplitude of said spring at t₂,
ζ is a damping ratio of said spring, and
ω satisfies the equation ω=ωᵢ\sqrt{1−2ζ²}, where ωᵢ is the natural frequency of said spring.

4. The method according to claim 2, wherein a difference between the two different time points is a period of the natural frequency of the corresponding spring.

5. The method according to claim 2, wherein if one of the two time points is t₁, a sampling rate of the input sound is SR, and a period of the natural frequency of the corresponding spring is T, then the other t₂ of the two time points is calculated by the equation below.
t₂=[t₁+SR×T+0.5]

6. The method according to claim 2, wherein the expected steady-state amplitude is calculated by substituting amplitudes at least two points in the duration of the input sound into the following equation and using a linear regression analysis:
A(t)=Aₛ+(A_{c}−Aₛ)e^{-ζω(t-t}^{_{c}}⁾
where A(t) is an amplitude of any spring among said plurality of springs at t,
Aₛ is the expected steady-state amplitude of said spring,
A_{c} is an amplitude of said spring at t_{c},
ζ is a damping ratio of said spring, and
ω satisfies the equation ω=ωᵢ\sqrt{1−2ζ²}, where ωᵢ is the natural frequency of said spring.

7. The method according to claim 1, wherein said modeling step comprises the steps of:
measuring displacements and velocities at time points for each of the plurality of springs;
calculating an energy at each time point for each of the plurality of springs based on the displacements and the velocities; and
calculating an amplitude at each time point for each of the plurality of springs based on the energy.

8. The method according to claim 1, wherein the number of the plurality of springs is determined based on a range and a resolution of the frequency to be extracted.

9. A computer-readable recording medium on which the method for extracting a frequency of an input sound according to claim 1 is recorded.

10. A device for extracting a frequency of a sound comprising:
a spring modeling unit for producing displacements and velocities of a plurality of springs by modeling the plurality of springs which have natural frequencies different from each other and oscillate according to the input sound; and
a frequency extracting unit for calculating transient-state-pure-tone amplitudes of the plurality of modeled springs, calculating expected steady-state amplitudes of the plurality of modeled springs, calculating predicted pure-tone amplitudes on the basis of the expected steady-state amplitudes; calculating filtered pure-tone amplitudes by multiplying the transient-state-pure-tone amplitudes with the predicted pure-tone amplitudes, and extracting the natural frequency of the spring which corresponds to a local maximum value among the filtered pure-tone amplitudes.

11. A method, of which each step is performed by a computer, for extracting a frequency of an input sound comprising the steps of:
modeling a plurality of springs which have natural frequencies different from each other and oscillate according to an input sound;
estimating an expected steady-state amplitude of the spring of which the amplitude is the highest among the plurality of modeled springs;
calculating an energy of the spring of which the amplitude is the highest based on the expected steady-state amplitudes; and
calculating an amplitude of the input pure tone based on the energy.

12. The method according to claim 11, wherein said expected steady-state amplitude (A_{i,s}) is calculated by the equation below:
$${A}_{i , s} = \frac{{A}_{i} ( {t}_{2} ) - {A}_{i} ( {t}_{1} ) {e}^{- ζ ω ( {t}_{2} - {t}_{1} )}}{1 - {e}^{- ζ ω ( {t}_{2} - {t}_{1} )}}$$
in which t₁ and t₂ are two time points within a duration of input sound satisfying t₂>t₁,
Ai(t₁) is an amplitude of a spring of which the amplitude is the highest in a frequency range at t₁,
Ai(t₂) is an amplitude of a spring of which the amplitude is the highest in a frequency range at t₂,
ζ is a damping ratio of said spring, and
ω satisfies the equation ω=ωᵢ\sqrt{1−2ζ²}, where ωᵢ is the natural frequency of said spring of which the amplitude is the highest.

13. The method according to claim 11, wherein said modeling step comprises the steps of:
measuring a displacement and a velocity at each time point for each of the plurality of springs;
calculating an energy at each time point for each of the plurality of springs based on the displacement and the velocity; and
calculating an amplitude at each time point for each of the plurality of springs based on the energy.

14. A computer-readable recording medium on which the method for extracting a frequency of an input sound according to claim 11 is recorded.

15. A device for extracting a frequency of an input sound comprising:
a spring modeling unit for producing displacements and velocities of a plurality of springs by modeling the plurality of springs which have natural frequencies different from each other and oscillate according to an input sound; and
a frequency extracting unit for estimating an expected steady-state amplitude of a spring of which the amplitude is the highest among the plurality of modeled springs, calculating an energy of a spring of which the amplitude is the highest based on the expected steady-state amplitudes, and calculating an input pure tone amplitude based on said energy.

16. A method for extracting a frequency of an input sound, which is performed by a computer, wherein:
when the frequency of the input sound maintains a first value by a certain point of time and turns into a second value at the turning point,
a result of frequency transform by the certain point indicates the first value, and
immediately after the turning point, a transient error of the transformed value is within 10% of the second frequency.

17. The method according to claim 16, wherein the method comprising the steps of:
modeling a plurality of springs which have natural frequencies different from each other and oscillate according to an input sound;
calculating transient-state-pure-tone amplitudes of the plurality of modeled springs;
calculating expected steady-state amplitudes of the plurality of modeled springs;
calculating predicted pure-tone amplitudes based on the expected steady-state amplitudes;
calculating filtered pure-tone amplitudes by multiplying the pure-tone amplitudes with the predicted pure-tone amplitudes; and
extracting the natural frequency of the spring which corresponds to a local maximum value among the filtered pure-tone amplitudes.
